(19) United States
(12) Patent Application Publication
(10) Pub. No.: US 2007/0056841 A1
(43) Pub. Date: Mar. 15, 2007

(54) System and method for the manufacture of hydrogen cyanide and acrylonitrile with simultaneous recovery of hydrogen

(76) Inventors: Pradeep K. Agarwal, Laramie, WY (US); John Ackerman, Laramie, WY (US); Ron Borgialli, Laramie, WY (US); Jerry Hamman, Laramie, WY (US); Suresh Muknahallipatna, Laramie, WY (US); Ji-Jun Zhang, Laramie, WY (US)

Correspondence Address: Emery L Tracy, P O Box 1518, Boulder, CO, 80306, US

(21) Appl. No.: 10/528,370

(22) PCT Filed: Sep. 17, 2003
(86) PCT No.: PCT/US03/29419

§ 371 Date: Jun. 29, 2006

Related U.S. Application Data
(60) Provisional application No. 60/411,816, filed on Sep. 18, 2002.

(51) Int. Cl. H05F 3/00; B01J 19/08

(52) U.S. Cl. 204/164; 422/186.04

(57) ABSTRACT

A system and method for the manufacture of hydrogen cyanide, acrylonitrile, and acetonitrile are provided. The system comprises at least one pulsed corona discharge reactor with each pulsed corona discharge reactor having a reaction zone. At least one reactant feed stream containing hydrogen is introduced into the pulsed corona discharge reactor and contacting the catalyst wherein hydrogen is removed from the reactant to form hydrogen cyanide, acrylonitrile, and acetonitrile.

The present application is a continuation and claims priority of pending provisional patent application Ser. No. 60/411,816, filed on Sep. 18, 2003, entitled “System and Method for the Manufacture of Hydrogen Cyanide and Acrylonitrile with Simultaneous Recovery of Hydrogen”.

### BACKGROUND OF THE INVENTION

1. Field of the Invention

This invention relates generally to system and method for the manufacture of hydrogen cyanide and acrylonitrile and, more particularly, the invention relates to system and method for the manufacture of hydrogen cyanide and acrylonitrile with simultaneous recovery of hydrogen in a pulsed corona discharge reactor.

2. Description of the Prior Art

Hydrogen cyanide is used for the production of chemical intermediates employed in the manufacture of nylon acrylic sheetings and coatings (methyl methacrylate), gold mining chemicals, animal feed supplements, water treatment, agricultural chemicals and herbicides, pharmaceuticals, household products, chelating products, among others. The annual production of cyanide (as HCN) actually exceeds 1.25 million metric tons per annum. Though several processes are available for the manufacture of HCN, the most popular are:
Shawnigan process:
The following reaction is employed:
   3 NH₃+C₃H₈→3 HCN+7 H₂
Andrussow process:
This process, widely used for the manufacture of HCN, involves the use of the autothermal reactions of ammonia, methane and air over a platinum and rhodium gauze catalyst. The overall reaction can be represented as
   NH₃+CH₄+(3/2)O₂→HCN+3 H₂O
A variant, with the addition of a lower amount of oxygen, leads to the formation of both hydrogen and water. Thus,
   NH₃+CH₄+O₂→HCN+H₂O+H₂
BMA process:
   NH₃+CH₄→HCN+3 H₂

HCN can also be produced as a by-product in the manufacture of acrylonitrile (ACN, CH₂═CHCN) using the SOHIO process for the ammoxidation of propylene and ammonia. Air, ammonia and propylene are reacted in the presence of catalyst at 5-30 psig, and temperatures of 1000° F. Approximately, 1.5 billion pounds of ACN are produced each year in the U.S. alone. The major use is in the production of acrylic and modacrylic fibers—these fibers are marketed under the trade names Acrilan, Creslan, Verel, among others. Other uses include manufacture of acrylonitrile-butadiene-styrene (ABS) and styrene-acrylonitrile (SAN) resins, nitrile elastomers, and other chemicals. Acrylonitrile is also used as a fumigant.

In all these processes, as also noted earlier, platinum and rhodium based catalysts are necessary; in addition, high-temperature operation is required. The controlled addition of oxygen (air) provides the heat necessary for the reaction, and also permits regeneration of the catalyst.

### SUMMARY

The present invention is a system for the manufacture of hydrogen cyanide, acrylonitrile, and acetonitrile. The system comprises at least one pulsed corona discharge reactor with each pulsed corona discharge reactor having a reaction zone. At least one reactant feed stream containing hydrogen is introduced into the pulsed corona discharge reactor and contacting the catalyst wherein hydrogen is removed from the reactant to form hydrogen cyanide, acrylonitrile, and acetonitrile.

In addition, the present invention includes a system for the manufacture of hydrogen cyanide, acrylonitrile, and acetonitrile. The system comprises a pulsed corona discharge reactor and a feed stream introduced into the pulsed corona discharge reactor wherein the following reaction is created:
hydrocarbon+ammonia+oxygen+nitrogen→HCN+ACN+acetonitrile+carbon oxides+hydrogen+water.

The present invention further includes a method for manufacturing hydrogen cyanide, acrylonitrile, and acetonitrile. The method comprises providing at least one pulsed corona discharge reactor with each pulsed corona discharge reactor having a reaction zone, positioning a catalyst in the reaction zone, introducing at least one reactant feed stream containing hydrogen into the pulsed corona discharge reactor and contacting the catalyst, and removing hydrogen from the reactant to form hydrogen cyanide, acrylonitrile, and acetonitrile.

### BRIEF DESCRIPTION OF THE DRAWINGS

FIG. 1a is a schematic view illustrating a system and method, constructed in accordance with the present invention, wherein hydrocarbon and ammonia are the reactants;

FIG. 1b is a schematic view illustrating a system and method, constructed in accordance with the present invention, with the inclusion of a suitable solid phase catalyst within the reaction zone;

FIG. 1c is a schematic view illustrating a system and method, constructed in accordance with the present invention, with air, oxygen, and/or nitrogen being introduced;

FIG. 1d is a schematic view illustrating a system and method, constructed in accordance with the present invention, with a feed stream similar to FIG. 1c, but with use of a suitable solid phase catalyst in the reaction zone; and

FIG. 1e is a schematic view illustrating a system and method, constructed in accordance with the present invention, with hydrocarbon and ammonia being fed into separate discharge reactors for generation of the appropriate radicals.

### DETAILED DESCRIPTION OF THE PREFERRED EMBODIMENTS

Hydrogen cyanide and acrylonitrile are important chemical intermediates used in a variety of applications of importance in the chemical, pharmaceutical, and mining industry. The present invention is a system and method for the manufacture of hydrogen cyanide and acrylonitrile, in particular, as well as acetonitrile. The reactants—ammonia, and hydrocarbons, for example, methane—are brought into contact in a single or plurality of pulsed corona or silent barrier discharge reactor(s). The reaction zone within the discharge reactor may contain suitable catalyst. Air, oxygen and/or other combinations of nitrogen and oxygen may be added to the feed stream depending on the product stream desired. The walls of the reactor are preferably constructed from membrane materials suitable for the selective continuous removal of hydrogen—formed from the decomposition of the ammonia and hydrocarbon(s)—from the reaction zone. Continuous removal of hydrogen from the reaction zone drives the reaction toward completion, and provides an important product stream.

As described above, the system and method of the present invention is the manufacture of HCN and acrylonitrile, in particular, as well as acetonitrile. The reactants—ammonia, and hydrocarbons, for example, methane—are brought into contact in a single or plurality of pulsed corona or silent barrier discharge reactor(s). The reaction zone within the discharge reactor may contain suitable a catalyst. Air, oxygen and/or other combinations of nitrogen and oxygen may be added to the feed stream depending on the product stream desired. Inert gases, for example, argon and/or helium may be added also to increase the density of ions in the reaction zone. Thus,
Hydrocarbon+ammonia+oxygen+nitrogen→HCN+ACN+acetonitrile+carbon oxides+hydrogen+water
Hydrocarbon species used would depend on the final product requirement—examples include methane, ethane, propane, propylene, and ethylene, among others.

Pulsed corona and silent barrier discharge systems do not appear to have been used for these reactions. In these reactors, a non-thermal plasma is formed in the reaction zone, and the reactions of interest are facilitated. Examples of the use of these reactors for other applications—notably in the area of NOₓ destruction, and the treatment of hydrogen sulfide—have been reported. Note that non-equilibrium, or non-thermal, plasmas have been divided into five distinctive groups depending on the mechanism used for their generation, applicable pressure range, and electrode geometry. These are as follows:
Glow discharge: This is an essentially low-pressure phenomenon usually between flat electrodes. The low pressure and mass flow severely restrict chemical industrial application.
Corona Discharge: Use of inhomogeneous electrode geometries permits stabilization of discharges at high pressure. Several specific regions of operation—for example, ac or dc, and pulsed—have been described in the literature for applications involving, most often, cleanup of flue gas and atmospheric pollutants. The AC/DC corona discharges, however, are inefficient in their higher energy consumption.
Silent Discharge: In this operational regime, one or both of the electrodes are covered with a dielectric layer. Application of a sinusoidal (or other time-varying) voltage, then, leads to pulsing electric fields and micro-discharges similar to those observed in pulsed corona discharge systems.
RF Discharge: In such systems, the electrodes are not an integral part of the discharge volume. Non-thermal (or non-equilibrium) conditions are expected only at low pressures, whereas thermal or equilibrium plasmas can be expected at high pressures—and larger production rates—of interest in the chemical process industry.
Microwave Discharge: Here, similar to RF discharge systems, the electrodes are not an integral part of the discharge volume. The wavelength of the applied electromagnetic field becomes comparable to the dimensions of the discharge volume and necessitates other coupling mechanisms.
   In comparing these non-thermal plasmas, it must be noted that in a glow discharge, the electrons gain energy from the applied field. Due to low pressures, collision with neutral species is infrequent. Propensity for the creation of reactive ions and chemical species is limited. Steady state operation is governed, primarily, by loss of energy incurred by the electrons on enclosure walls and other surfaces within the reactor. The situation is similar in RF and microwave discharges. In corona and silent discharges, the situation is entirely different—the fast electrons do indeed transfer energy to other molecules in the system. Electrode geometry and construction prevent sparking or arcing. The collision between electrons and the molecules leads to the production of ions and reactive species that facilitates chemical reaction at ostensibly low temperatures. The pulsing of the corona discharge permits significant reduction in the power consumption.

Another distinguishing feature of the proposed process is the use of pulsed corona and silent barrier discharge reactors that permit selective removal of hydrogen from the reaction zone. Many reactions of importance in the process and petroleum industry are limited by thermodynamic constraints on (closed system) equilibrium conversion. In such reactions, the reactant conversion can often be enhanced by use of membrane reactors that operate on the principle of continuous/intermittent removal of products from the reaction zone. A particularly important category of such reactors is that based on the use of (catalytic, or non-catalytic) reactors membranes that are selective to the permeation of hydrogen. This configuration permits overcoming the equilibrium conversion limitations, and provides a relatively pure stream of hydrogen that may be
recycled to the refinery for use in hydrogenation applications; and/or
used as a clean fuel—in a fuel cell, or in direct combustion applications.
   For example, an inventor of the present application has described the use of pulsed corona and silent barrier discharge reactors for the decomposition of H₂S; the reactor walls, constructed from hydrogen-permeable membrane materials remove hydrogen from the reaction zone and serve simultaneously as an electrode. High voltage pulses, with duration of about tens of nanoseconds, create an intense electric field most in the reaction zone leading to the formation of a non-thermal plasma. The temperature of the electrons formed from the ionization of the gaseous medium, as characterized by electron velocity/energy, is much higher than the temperature of the much larger bulk gas molecules and other ionic/charged/excited species.

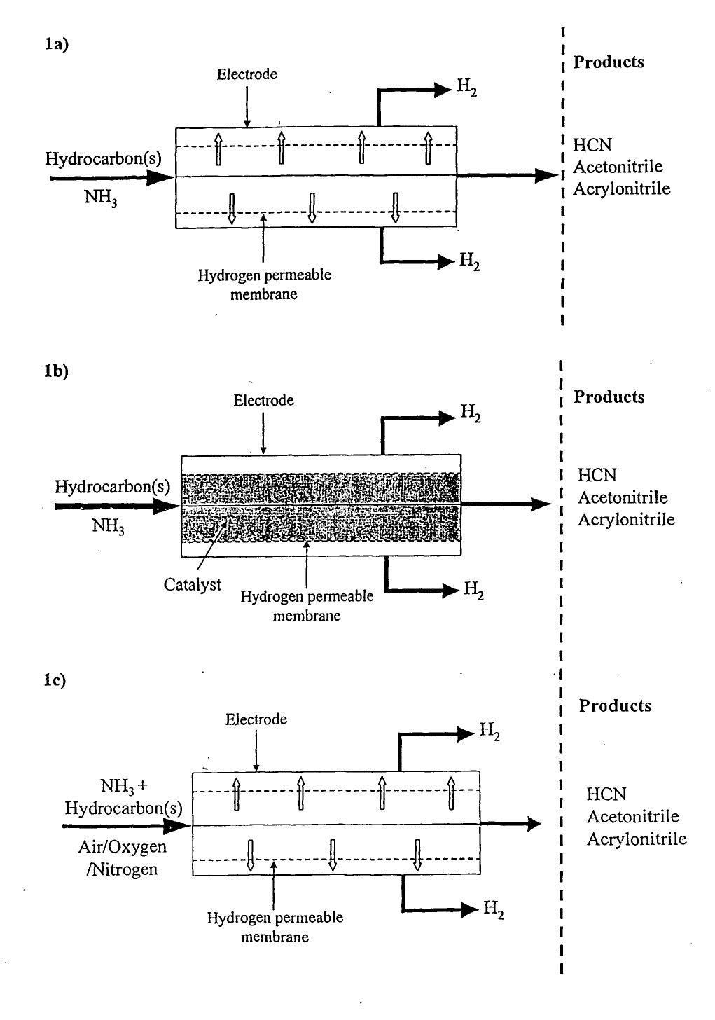

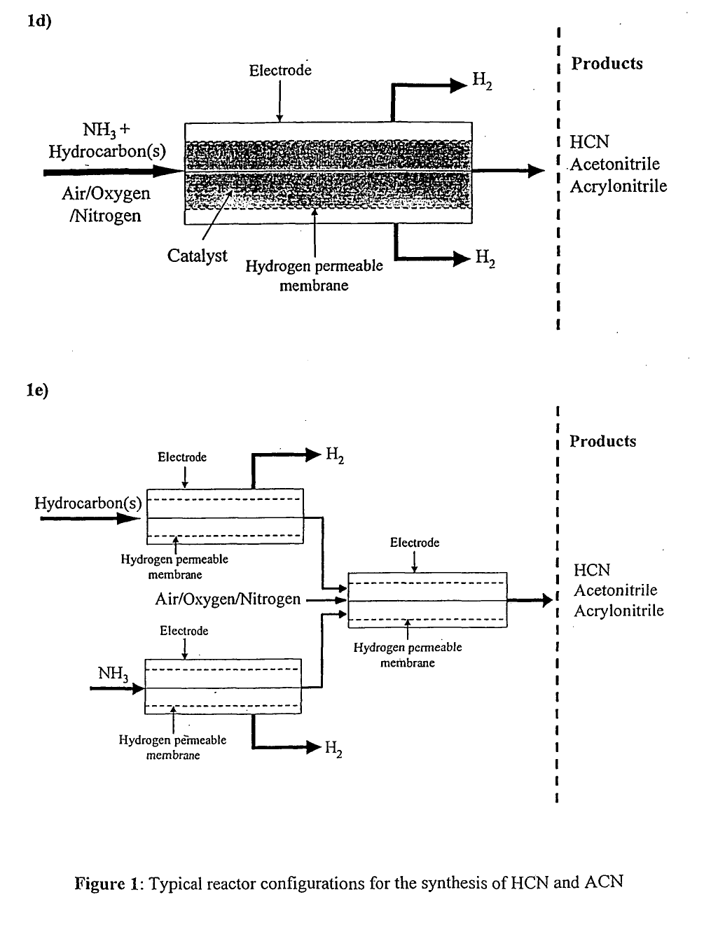

Examples of possible configurations are illustrated in FIG. 1. In FIG. 1a, a hydrocarbon and ammonia are the reactants. FIG. 1b illustrates the inclusion of a suitable solid phase catalyst within the reaction zone. In FIG. 1c, the addition air, oxygen, and/or nitrogen is shown; FIG. 1d illustrates a similar feed stream but with use of a suitable solid phase catalyst in the reaction zone. In FIG. 1e, the hydrocarbon and ammonia are fed into separate discharge reactors for generation of the appropriate radicals; these radicals are combined, in the presence of a suitable solid phase catalyst if necessary, in a separate reaction chamber. Air, oxygen and/or nitrogen may be added in these reactors. Other combination(s) of such reactors are also possible.

The major advantages of the proposed process are as follows:
The operation can be carried out at low temperatures with or without the use of expensive catalyst.
The reactor operation can be brought on-line, or shut off, through instantaneous control of electrical current and voltage, which adds a large margin of safety to production of this toxic material. Expensive and extensive clean-up procedures following shutdown, necessary in the conventional catalytic high-temperature operation, are rendered unnecessary.
Removal of hydrogen from the reaction zone permits recovery of a valuable commodity. It also permits driving the reaction towards completion.
The product mix can be controlled readily.

Reactant conversion or product yield can often be enhanced by use of membrane reactors that operate on the principle of continuous/intermittent removal of products from the reaction zone. An important category of such reactors is that based on the use of membranes that are selective to the permeation of hydrogen. In the present invention, a system and method is described for the characterization of hydrogen-permeable membranes. The system and method of the present invention will, in particular, find application where the permeability of hydrogen has to be measured for membranes to be used in reactors that employ electrical/electrochemical/photo-electrochemical fields that lead to generation of hydrogen.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein, may be suitably practiced in the absence of the specific elements which are disclosed herein.

What is claimed is:

1. A system for the manufacture of hydrogen cyanide, acrylonitrile, and acetonitrile, the system comprising:
at least one pulsed corona discharge reactor, each pulsed corona discharge reactor having a reaction zone; and
at least one product stream containing hydrogen produced in the pulsed corona discharge reactor and contacting the catalyst;
wherein hydrogen is removed from the reactant to form hydrogen cyanide, acrylonitrile, and acetonitrile.

2. The system of claim 1 wherein the pulsed corona discharge reactor has walls, the walls being constructed from membrane materials suitable for the selective continuous removal of hydrogen formed from the decomposition of the ammonia and hydrocarbon(s) in the reaction zone wherein the continuous removal of hydrogen from the reaction zone drives the reaction to completion.

3. The system of claim 1 wherein the reactant feed stream has an additive selected from the group consisting of air, oxygen and other combinations of nitrogen and oxygen.

4. The system of claim 1 wherein the reactant feed stream includes ammonia and hydrocarbons.

5. The system of claim 4 wherein the hydrocarbons include methane, ethane, propane, propylene, and ethylene.

6. The system of claim 1 and further comprising:
inert gases added to the reaction zone for increasing the density of ions in the reaction zone.

7. The system of claim 1 wherein the pulsed corona discharge reactor operates on continuous/intermittent removal of products from the reaction zone.

8. The system of claim 1 and wherein the reactants are hydrocarbon and ammonia, a solid phase catalyst is positioned within the reaction zone, and air, oxygen, and/or nitrogen are added to the feed stream.

9. The system of claim 1 wherein the reaction zone contains a catalyst.

10. A system for the manufacture of hydrogen cyanide, acrylonitrile, and acetonitrile, the system comprising:
a pulsed corona discharge reactor; and
a feed stream introduced into the pulsed corona discharge reactor;
wherein the following reaction is created:
hydrocarbon+ammonia+oxygen+nitrogen→HCN+ACN+acetonitrile+carbon oxides+hydrogen+water.

11. A method for manufacturing hydrogen cyanide, acrylonitrile, and acetonitrile, the method comprising:
providing at least one pulsed corona discharge reactor, each pulsed corona discharge reactor having a reaction zone;
positioning a catalyst in the reaction zone;
introducing at least one reactant feed stream containing hydrogen into the pulsed corona discharge reactor and contacting the catalyst; and
removing hydrogen from the reactant to form hydrogen cyanide, acrylonitrile, and acetonitrile.

12. The method of claim 11 and further comprising:
constructing the walls of the pulsed corona discharge reactor has walls from membrane materials suitable for the selective continuous removal of hydrogen formed from the decomposition of the ammonia and hydrocarbon(s) in the reaction zone wherein the continuous removal of hydrogen from the reaction zone drives the reaction to completion.

13. The method of claim 11 and further comprising:
introducing an additive selected from the group consisting of air, oxygen and other combinations of nitrogen and oxygen into the reactant feed stream.

14. The method of claim 11 and further comprising:
adding ammonia and hydrocarbons into the reactant feed streams.

15. The method of claim 14 wherein the hydrocarbons include methane, ethane, propane, propylene, and ethylene.

16. The method of claim 11 and further comprising:
increasing the density of ions in the reaction zone with inert gases added to the reaction zone.

17. The method of claim 11 and further comprising:
operating the pulsed corona discharge reactor on continuous/intermittent removal of products from the reaction zone.

18. The method of claim 11 and wherein the reactants are hydrocarbon and ammonia, a solid phase catalyst is positioned within the reaction zone, and air, oxygen, and/or nitrogen are added to the feed stream.
